(19) United States
(12) Patent Application Publication
(10) Pub. No.: US 2026/0331922 A1
(43) Pub. Date: Oct. 22, 2026

(54) CONTROL ARCHITECTURE OF A SYSTEM FOR PRODUCTION, STORAGE AND DISTRIBUTION OF ELECTRICITY AND HYDROGEN

(71) Applicant: DUMAREY Automotive ltalia S.p.A., Torino (IT)

(72) Inventors: Vincenzo Alfieri, Torino (IT); Giulio Binetti, Torino (IT); Edoardo Gandino, Torino (IT)

(73) Assignee: DUMAREY Automotive ltalia S.p.A., Torino (IT)

(21) Appl. No.: 19/114,718

(22) PCT Filed: Sep. 25, 2023
(86) PCT No.: PCT/IB2023/059452

§ 371 Date: Mar. 24, 2025

(30) Foreign Application Priority Data
Sep. 30, 2022 (IT) 102022000020211

(51) Int. Cl. H02J 3/38; G05B 19/05; H02J 3/00; H02J 3/32; H02J 103/30

(52) U.S. Cl. CPC H02J 3/38; G05B 19/05; H02J 3/004; H02J 3/32; G05B 2219/15097; H02J 2103/30

(57) ABSTRACT

The present invention is related to a control architecture of a system for production, storage and distribution of electricity and hydrogen, where the control architecture, based on optimization and self-learning strategies (machine learning) capable of managing the trade-off between the needs of users who are in conflict with each other.

It maximizes the economic benefit for energy and hydrogen users, maximizing the useful life of the components. The control architecture exploits optimal predictive control and self-learning of both the trends in energy generation from renewable sources (RES) and the behavior of users in real operating situations.

This is based on a model-based predictive control (MPC) algorithm which is a model-based control methodology to address constrained multi-variable control problems, exploiting a model to predict the future evolution of the system up to a predetermined time horizon.

### TECHNICAL FIELD OF THE INVENTION

The present invention is related to a control architecture of a system for production, storage and distribution of electricity and hydrogen, particularly to control architecture of a system for production, storage and distribution as defined in the preamble of claim 1.

### BACKGROUND ART

A production, storage and distribution (PSD) facility is a complex system that must be controlled in real time by determining set-points for all components of the system, to achieve the desired hydrogen power and flows, as well as the power and flow of electricity possibly produced, in order to satisfy multiple plant targets.

Multiple control methods are known relating to the individual phases of hydrogen plants: methods linked to the control of hydrogen production, methods for hydrogen storage, strategies for its optimal distribution, depending on the needs of users.

It is much more complex to define a global control strategy for complex PSD systems which perhaps also include the production and distribution of electricity.

The critical point, from the user's point of view, is the optimal definition in real time of all the power set-points for each component of the PSD system: think, for example, to the electrolyser, to the compressor, to fuel cells, to batteries, as well as further electrical components and any distribution network.

Real-time optimization of set-point values must take into account a predetermined cost function and the required performance metric, while satisfying all component and system level constraints and considering the impacts of possible different uncertainties. Uncertainties that are present and have a heavy impact when, for example, the generation of electricity also from renewable energy sources (RES) is envisaged or, in any case, is linked to highly variable demand from users of electricity and hydrogen. These uncertainties risk compromising the performance of the PSD plant in the real operational scenario.

There is therefore a need to define a control architecture of a system for production, storage and distribution of electricity and hydrogen that is free of the above-mentioned drawbacks.

### SUMMARY OF THE INVENTION

To substantially resolve the technical problems highlighted above, an aim of the present invention is a control architecture, based on optimization and self-learning strategies (machine learning) capable of managing the trade-off between the needs of users who are in conflict with each other.

These contrasting needs can be, for example: maximizing the economic benefit for the owner of the PSD system, maximizing the economic benefit for energy and hydrogen users, maximizing the useful life of the components.

The control architecture, according to the present invention, exploits optimal predictive control and self-learning of both the trends in energy generation from renewable sources (RES) and the behavior of users in real operating situations.

The proposed strategy is based on a model-based predictive control (MPC) algorithm which is a model-based control methodology to address constrained multi-variable control problems, exploiting a model to predict the future evolution of the system up to a predetermined time horizon.

Indeed, the proposed strategy can effectively satisfy component constraints (e.g., minimum and maximum allowed operating range, etc.) and system-level constraints, with particular attention to power constraints, balancing and stability of electric power in the PSD plant.

Therefore, according to the present invention there is provided a control architecture of a system for production, storage and distribution of electricity and hydrogen having the characteristics set forth in the independent claim, annexed to the present description.

Further embodiments of the invention, preferred and/or particularly advantageous, are described according to the characteristics set forth in the attached dependent claims.

### BRIEF DESCRIPTION OF THE DRAWINGS

The invention will now be described with reference to the attached drawings, which illustrate some non-limiting embodiments, in which:

FIG. 1 is a diagram of a system for the production, storage and distribution of electricity and hydrogen, and

FIG. 2 is a logical diagram of a control architecture of the system of FIG. 1, according to a preferred embodiment of the present invention.

### DETAILED DESCRIPTION

By way of purely illustrative and non-limiting example, the control architecture of a system for production, storage and distribution will now be described with reference to the aforementioned figures.

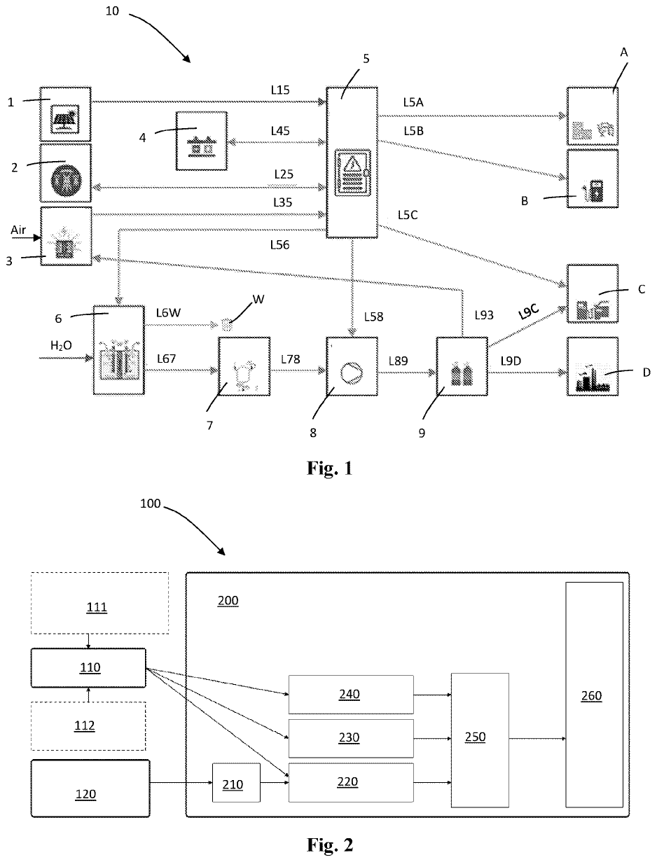

With particular reference to FIG. 1, a system for production, storage and distribution of electricity and hydrogen is identified with reference 10.

By way of example, system 10, as regards the generation and distribution of electrical energy, includes:
a generator 1 of energy from renewable sources that produces electricity at a certain cost,
an electricity distribution network 2 that can sell electricity at a first price and can buy electricity at a second price not necessarily equal to the first price,
a fuel cell 3 which, receiving air from the external environment and hydrogen from its storage and distribution system, produces electricity,
a battery 4 or a group of batteries, to supply or store electrical energy,
an electrical power distribution unit 5, equipped with input ports for the different sources of electrical energy and output ports for one or more users,
while for the production, storage and distribution of hydrogen, system 10 includes:
an electrolyser 6, which, receiving water from external sources and electricity from the distribution unit 5, produces hydrogen and disposes of the oxygen made available by the electrolysis process,
a first hydrogen tank 7 for the accumulation of hydrogen at low pressure, as produced by the electrolyser,
a compressor 8 to allow the hydrogen to reach the required pressure level,
a second high-pressure hydrogen tank 9 for the storage and distribution of the hydrogen to the users and/or to the fuel cell 3.

The users of system 10 for the production, storage and distribution of electricity and hydrogen have been schematized, again by way of example:
a first user A of electricity to whom the committed electrical power is sold at a first price, for example, a home or a company office,
a second user B of electrical energy to whom the committed electrical power is sold at a second price, not necessarily the same as the first, for example, an electric charging station for hybrid or electric propulsion vehicles,
a first user C of hydrogen to whom the hydrogen is sold at a first price, for example, a hydrogen charging station for fuel cell vehicles,
a second user D of hydrogen to whom the hydrogen is sold at a second price, not necessarily the same as the first, for example, an industrial plant.

The plant connections are as follows:
the energy sources, generator 1 from renewable sources, distribution network 2, fuel cell 3 and battery 4 are all electrically connected to the distribution unit 5, via the corresponding lines L15, L25, L35, L45. It should be noted that line 25-electricity from network 2 to distribution unit 5—is bidirectional as the electricity, depending on needs, can be sold to distribution network 2 and not purchased from it. The L45 line is also bidirectional as the battery 4 can act both as a dispenser and as a storage of electrical energy.

The PSD system relating to hydrogen works in series: line 67 transports hydrogen from the electrolyser 6 to the first low pressure hydrogen storage tank 7, while line 6W disposes of the oxygen produced by the electrolyser in a special disposal W. Line 78 transports hydrogen from the first tank 7 to the compressor 8, while line 89 transports hydrogen from the compressor 8 to the second tank 9 for storage and distribution of the pressurized hydrogen.

Electricity distribution takes place from distribution unit 5 by means of:
L5A line towards the first electricity user A,
line L5B towards the second electricity user B,
L5C line towards the first hydrogen user C for the electrical supply of the charging station components,
line L58 for powering compressor 8 for pressurizing hydrogen.

The distribution of hydrogen occurs from the second hydrogen tank 9 by means of:
L9C line towards the first hydrogen user C,
L9D line towards the second hydrogen user D,
line L93 towards fuel cell 3.

The present invention, taking as an example the system 10 for the production, storage and distribution of electricity and hydrogen, as described above, relates to a control architecture 100, provided with optimization and online self-learning strategies (machine learning) for optimal control of this system.

The control architecture 100 is designed to adequately consider uncertainties—such as, for example, power generation from renewable energy sources (RES), consumer demand for energy and hydrogen—that impact the performance of the PSD plant in order to achieve optimal performance in real life.

The optimization strategies are hybrid and stochastic, i.e., dynamic systems characterized by a continuous and a discrete dynamic component that interact with each other, and whose evolution is affected by uncertainty described by probabilistic laws.

In detail, a hybrid and stochastic optimization problem is designed (considering continuous and discrete variables through mixed-integer quadratic programming for a PSD plant).

The aim of the optimization strategies is to reduce the cost of the PSD plant, increasing the profits of the PSD plant owner and to increase the life of the components.

Online self-learning strategies are of two types.

A first self-learning strategy is related to learning the energy production of energy generator 1 from renewable sources, to be exploited with a predictive optimization approach. It is based on the following functions:
online learning of the power supplied by renewable sources, based on the measurements available from the PSD plant, exploiting techniques such as statistical models, artificial neural networks, Markov chains, etc.;
online forecast of the power supplied by renewable sources based on the meteorological information available (e.g., solar radiance, wind speed, temperature, etc.) from multiple web services, exploiting the models of photovoltaic panels and/or wind turbines, plus a renewable power correction model for the specific PSD plant based on actual versus predicted renewable energy production.

A second self-learning strategy is related to learning the behavior of users A, B, C, D of electricity and hydrogen, also to be exploited with a predictive optimization approach. It is based on the online learning function of energy and hydrogen consumer demands, leveraging techniques such as statistical models, artificial neural networks, Markov chains, etc., capable of learning typical patterns of energy and hydrogen demand, so as to provide predictions to the control architecture optimizer.

With reference to FIG. 2, the control architecture 100 according to the present invention includes a database 110 and a programmable logic controller 200.

The database 110 is a private database and collects a first type of information 111, which is available at the PSD plant. Advantageously, this information includes the energy production data from renewable sources (therefore the production of energy generator 1 from renewable sources in kW), the demand for electrical energy in kW per time window by electricity users A, B, C and the demand for hydrogen in kg/h per time window by hydrogen users C, D.

The database 110 also collects a second type of information 112. This is additional information which, preferably, includes: the cost of the energy purchased from the distribution network 2, specified per hour [€/kWh] and the price of the energy sold to distribution network 2, specified per hour [€/kwh].

Preferably, the control architecture 100 can also be based on public information 120 available, for example, via web services and, therefore, also accessible to the managers of the PSD system. This information could be:
prediction of solar radiation,
wind speed prediction,
prediction of environmental conditions (temperature, humidity, pressure).

The programmable logic controller 200 has a series of modules, each with different functions.

A first module is a dynamic model 210 of the generator 1 of energy from renewable sources. Generator 1 could be, for example, a photovoltaic system, a wind turbine, a geothermal Rankine cycle system and so on. The dynamic model 210 of generator 1 will use the public information 120, available via the web, updating the energy generation forecasts from RES in real time.

A first self-learning module 220 (first self-learning strategy) will be based on the first type of information 111 and on the second type of information 112 (as regards the production data and the related costs of energy from RES), available in the database 110 and will learn a real-time corrective model of the renewable energy generation forecast based on the dynamic model 210 and therefore on public information 120. This allows for a better “local” forecast for approximately 24 hours.

A second self-learning module 230 (second self-learning strategy) is related to the requests for electricity by users A, B, C. It will also be based on the first type of information 111 and on the second type of information 112 (for that which concerns the demand for electricity in kW per time window by users) and will learn the trend of requests relating, for example, to a charging station for electric vehicles or fuel cell vehicles or to a chemical industry.

A third self-learning module 240 (always relating to the second self-learning strategy) is related to the requests for hydrogen by users C, D. It will also be based on the first type of information 111 and on the second type of information 112 (for that which concerns the request for hydrogen in kg/h per time window by users) and will learn the trend of requests relating, for example, to a car (with hydrogen under pressure, for example, up to 700 bar) or to a bus (with hydrogen under pressure, for example, up to 350 bar).

The use of results based on self-learning strategies will be used in the module for generating stochastic scenarios 250.

In this module you will therefore have a complete forecast, at least for the next 24 hours, of energy production from renewable sources and demand from energy and hydrogen users.

The stochastic scenario will, finally, be used in the last module of the programmable logic controller 200, i.e., in the module 260 of predictive control algorithm. This algorithm, following the hybrid and stochastic approach, determines the optimal program for the PSD plant, including the strategy activation/deactivation switch for electrolyser 6, compressor 8, fuel cell 3.

The control architecture according to the present invention is therefore capable of increasing the performance of the plant in real life, subject to uncertainties on the production of energy from renewable sources and on the behavior of users of electricity and hydrogen. It therefore solves the technical problem of not compromising the performance of the PSD system in the real operating scenario.

In addition to the form of the invention as described above, it must be understood that there are numerous other variants. It must also be understood that these forms of embodiment are merely illustrative and do not limit either the scope of the invention, its applications or its possible configurations. On the contrary, although the above description allows the skilled person to implement the present invention at least according to one exemplary form of embodiment thereof, it should be understood that many variations of the described components are possible, without thereby departing from the scope of the invention as defined in the appended claims, which are interpreted literally and/or according to their legal equivalents.

1. A control architecture (100) of a system (10) for the production, storage and distribution of electricity and hydrogen, the system including means of generation (1, 2, 3, 4) and distribution (5) of electricity, means of production (6), storage (7) and distribution (9) of hydrogen and a plurality of electricity users (A, B, C) and hydrogen users (C, D), the control architecture (100) comprising a database (110) and a programmable logic controller (200), the control architecture (100) being characterized by the fact that the programmable logic controller (200) includes: at least one module (250, 260) configured to execute optimization strategies based on a hybrid and stochastic predictive control algorithm, for constrained multi-variable control problems, where the algorithm foresees the future evolution of the system up to a predetermined time horizon, at least one module (220, 230, 240) configured to perform online self-learning strategies of the trends in the generation of energy from renewable sources and the behavior of users in real operating situations.

2. The control architecture (100) according to claim 1, wherein the database (110) contains a first type of information (111), which includes data on energy production from renewable sources, electricity demand per time window by electricity users and hydrogen demand per time window by hydrogen users.

3. The control architecture (100) according to claim 1, or 2, wherein the database (110) contains a second type of information (112) which comprises the cost of the energy purchased from a distribution network (2) and the price of energy sold to the distribution network (2).

4. The control architecture (100) according to claim 1, further comprising public information (120) about environmental conditions prediction, said public information being available by means of web services.

5. The control architecture (100) according to claim 1, wherein the programmable logic controller (200) is provided with a dynamic model (210) of a renewable energy generator (1), the dynamic model using public information (120) and updating in real time the forecasts of energy generation from renewable sources.

6. The control architecture (100) according to claim 1, wherein the programmable logic controller (200) is provided with a first self-learning module (220) which exploits statistical models, artificial neural networks, Markov chains, is based on the first type of information (111) and on the second type of information (112) and learns a real-time corrective model of the forecast of energy generation from renewable sources based on the dynamic model (210).

7. The control architecture (100) according to claim 1, wherein the programmable logic controller (200) is provided with a second self-learning module (230) which exploits statistical models, artificial neural networks, Markov chains, is based on the first type of information (111) and on the second type of information (112) and learns the trend of electricity requests by electricity users (A, B, C).

8. The control architecture (100) according to claim 1, wherein the programmable logic controller (200) is provided with a third self-learning module (240) which exploits statistical models, artificial neural networks, Markov chains, is based on the first type of information (111) and on the second type of information (112) and learns the trend of hydrogen requests by hydrogen users (C, D).

9. The control architecture (100) according to claim 1, wherein the programmable logic controller (200) is provided with a module for generating stochastic scenarios (250).

10. The control architecture (100) according to claim 1, wherein the programmable logic controller (200) is provided with a module (260) configured to perform optimization strategies based on the predictive control algorithm which, following the hybrid and stochastic approach, determines the optimal program for the system (10).
